(19) United States
(12) Patent Application Publication
(10) Pub. No.: US 2010/0053401 A1
(43) Pub. Date: Mar. 4, 2010

(54) Method and Apparatus for Imaging

(75) Inventor: Takashi Tsuda, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/406,795

(22) Filed: Mar. 18, 2009

(30) Foreign Application Priority Data
Aug. 29, 2008 (JP) 2008-222296

(51) Int. Cl. H04N 5/335; G06K 9/00

(52) U.S. Cl. 348/311; 382/167; 348/E05.091

(57) ABSTRACT

According to one embodiment, a shading correction circuit, which corrects for the influence of ambient light quantity shading, for input image light from three CCD sensors of R, G and B, based on a distance from the center of a screen. A shading correction circuit does not make correction for a maximum correction area which is out of a circle with a distance a from the central part of a screen, and corrects for the influence of ambient light quantity shading for a minimum correction area with a distance b from the central part of a screen, after calculating a square L² of an address distance of each pixel of a correction object obtained by using a vertical distance and a horizontal distance from an address of the central part of a screen.

### CROSS-REFERENCE TO RELATED APPLICATIONS

This application is based upon and claims the benefit of priority from Japanese Patent Application No. 2008-222296 filed Aug. 29, 2008, the entire contents of which are incorporated herein by reference.

### BACKGROUND

1. Field

One embodiment of the present invention relates to shading correction of the ambient light quantity of a lens, generated in an imaging apparatus using an imaging element such as a triple-CCD imaging apparatus.

2. Description of the Related Art

In an imaging apparatus for imaging an object by means of a lens, it has been known that light quantity around a lens is decreased with respect to image light entering at the center of a lens.

Thus, in an imaging apparatus, light quantity decreased in a marginal area is usually corrected as shading correction of ambient light quantity.

Japanese Patent Application Publication (KOKAI) No. 2005-277618 discloses shading correction, in which a function of sum of a square of horizontal distance and vertical distance from the center of an image to each pixel is obtained by calculation, and is corrected for each color.

Japanese Patent Application Publication (KOKAI) No. 2004-165958 discloses correction of limb darkening by computing a function of sum of a square of horizontal distance X and vertical distance Y from the center of an image to each pixel.

Neither of the above patent applications mentions correction of a decrease in a signal level different for R, G and B, by using a triple-CCD imaging apparatus.

Both of the correction methods disclosed in the above patent applications needs large memory capacity for storing image data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an imaging apparatus to which an embodiment of the invention is applicable;

FIG. 2 is an exemplary diagram showing an example of relationship between a color separation prism incorporated in the imaging apparatus shown in FIG. 1, and a CCD sensor to output an image signal of a separated color component;

FIG. 3A is an exemplary diagram showing an example of a state with less ambient light quantity shading (to be corrected) specific to a lens incorporated in the imaging apparatus shown in FIG. 1;

FIG. 3B is an exemplary diagram showing an example of a state, in which ambient light quantity shading (to be corrected) specific to a lens incorporated in the imaging apparatus shown in FIG. 1 is greater than the lens shown in FIG. 3A;

FIG. 4 is an exemplary diagram showing an example of a cause of unevenness in color due to ambient light quantity shading, in the imaging apparatus show in FIG. 1;

FIG. 5A is an exemplary diagram showing an example of a state, in which ambient light quantity shading to be corrected occurs;

FIG. 5B is an exemplary diagram showing an example of parabolic correction, which is one of the methods of correcting ambient light quantity shading to be corrected explained in FIG. 5A;

FIG. 6 is an exemplary diagram showing an example of a correction system for ambient light quantity shading correction applied to the imaging apparatus shown in FIG. 1;

FIG. 7 is an exemplary diagram showing an example of the principle of correction in the ambient light quantity shading correction system shown in FIG. 6; and

FIG. 8 is an exemplary diagram showing an example of a correction data group stored in a ROM table used in the ambient light quantity shading correction system shown in FIG. 6.

### DETAILED DESCRIPTION

Various embodiments according to the invention will be described hereinafter with reference to the accompanying drawings. In general, according to one embodiment of the invention, an imaging apparatus comprising: a CCD sensor which converts input image light to an image signal; and a shading correction module which corrects the influence of ambient light quantity shading to input image light, for an image signal output from the CCD sensor whose distance from the center of a screen is farther than a predetermined distance, according to a circle with an equal distance from the center of a screen.

Embodiments of this invention will be described in detail with reference to the drawings. The various modules of the systems described herein can be implemented as software applications, hardware and/or software modules, or components on one or more computers, such as servers. While the various modules are illustrated separately, they may share some or all of the same underlying logic or code.

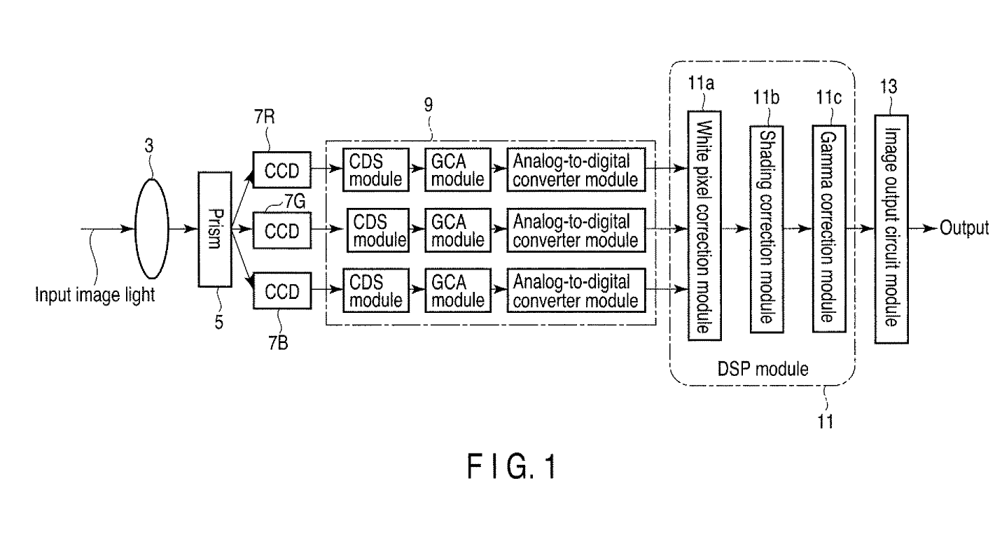

FIG. 1 is a schematic block diagram explaining an imaging apparatus to which an embodiment of the invention is applicable.

An imaging apparatus 1 shown in FIG. 1 includes a lens 3 to accept image light from an object, a prism 5 to separate the image light from the lens 3 into three primary colors, red (R), green (G) and blue (B) of additive color mixing, and a CCD sensor 7 (R, G, B) to convert the image light of R, G and B colors separated by the prism 5 to an input image signal.

The input image signal from the CCD sensor 7 (R, G, B) is decreased in a noise component through a preprocessor 9 (R, G, B), amplified to a predetermined gain, exposed to analog-to-digital conversion, and applied to a digital signal processor (DSP module) 11. The preprocessor 9 includes a correlated double sampling circuit module (CDS module) to eliminate a noise component from the input image signal from each CCD sensor, a gain control amplifier (GCA module) to give predetermined gain to the output of the CDS circuit module, and an analog-to-digital converter module to digitize an analog input image signal.

The digital signal processor (DSP module) 11 includes a white pixel correction module 11a which corrects a white pixel that is extremely increased when the sensitivity of the CCD sensor 7 (R, G, B) is increased or the storing time is prolonged, a shading correction module 11b which corrects the difference between the light quantities of image light passing through the center of the lens 3 and image light entering a peripheral area of the lens 3, among the image light whose white pixel is corrected by the white pixel correction module 11a, and a gamma (γ) correction module 11c which corrects the contrast of an input image signal.

It is to be noted that a single pulse is provided when a length of an information mark that should be recorded is the shortest unit 2T (T corresponds to one cycle of a basic clock frequency and 2T corresponds to a channel bit length in which two “1s” continue). Further, for example, a long pit like 11T is formed by applying a plurality of pulses. In order to form a smaller pit to realize a high capacity, a laser beam whose wavelength is shortened as much as possible must be combined with an objective lens having a high NA, but using a heat-sensitive resist film enables thermal formation of a small pit beyond an optical limit, especially a limit dependent on the wavelength of a laser beam.

The image signal corrected by the DSP module 11 is sent to a display unit (a monitor unit) or an image data storage unit (a large capacity storage module), through an image output circuit module (a camera link driver) 13, though they are not described in detail.

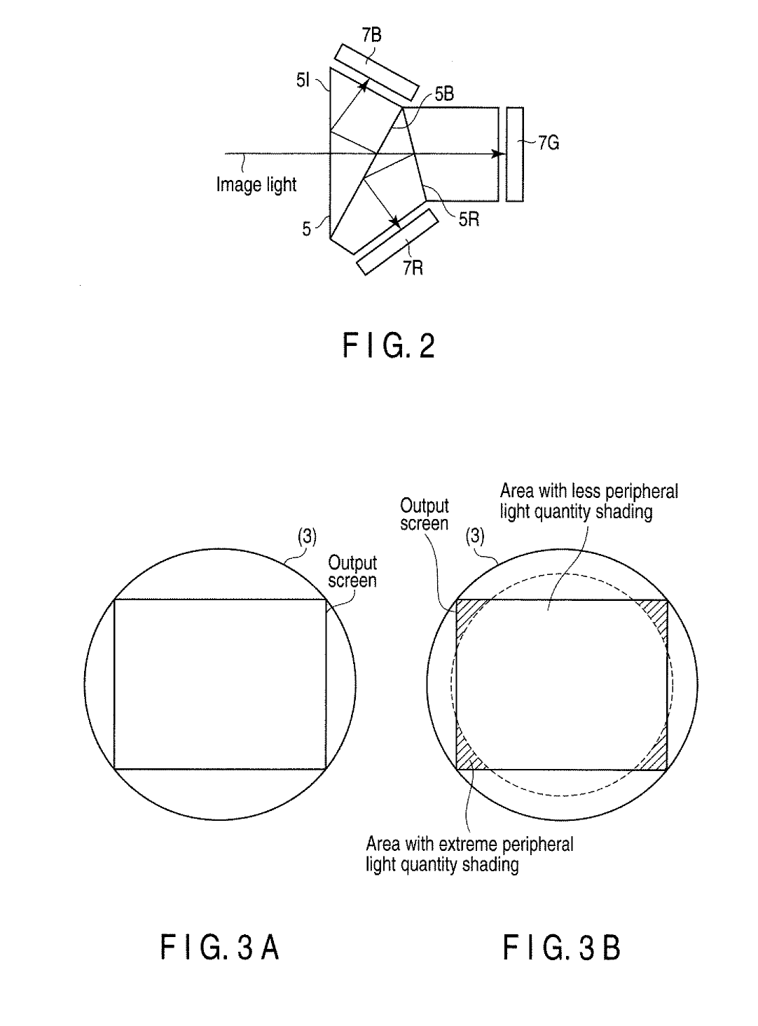

FIG. 2 shows an example of relationship between reflection planes of the prism 5, which reflect input image light to each channel of the CCD sensor 7, that is, color CCD sensors 7R, 7G and 7B, and each color prism.

Among the input image light entering the prism 5, an image component of a blue channel to be received by the channel B, or the CCD 7B, for example, is reflected by a first wavelength selection film 5B, then reflected by a light incident plane 51, and is guided to a not-described light-receiving surface of the CCD 7B. Among the input image light applied to the prism 5, an image component of a red channel to be received by the channel R, or the CCD 7R, for example, passes through a first wavelength selection film 5B, reflects on a second wavelength selection film 5R, reflects again on the backside of the first wavelength selection film 5B, and is guided to a not-described light-receiving surface of the CCD 7R. Among the input image light applied to the prism 5, an image component of a green channel to be received by the channel G, or the CCD 7G, for example, passes through a first wavelength selection film 5B and a second wavelength selection film 5R, and is guided to a not-described light-receiving surface of the CCD 7G.

By using the prism 5 shown in FIG. 2, the input image light entering through the lens 3 is converted to an input image signal for each color of R, G and B. In this embodiment, since the number of reflections of the image component of the green channel guided to the channel G, or the CCD 7G, in the prism 5 is minimum, it is used as a standard for correction of ambient light quantity shading (decrease in the quantity of light passing through a peripheral area of a lens) to be explained hereinafter.

Namely, in this embodiment, unevenness in color can be prevented by correcting the components R and B, with the component G fixed.

FIGS. 3A and 3B are schematic diagrams explaining the concept of the decrease in light quantity of the image light entering a peripheral area of a lens.

As seen from FIGS. 3A and 3B, ambient light quantity shading is known as a characteristic specific to the lens 3, which accepts input image light.

FIG. 3A conceptually shows the relationship between input image light passing through a lens (3) with less ambient light quantity shading, and brightness (light quantity) of an output screen (a CCD sensor output).

FIG. 3B conceptually shows the relationship between input image light passing through a lens (3) with much ambient light quantity shading, and brightness (light quantity) of an output screen (a CCD sensor output).

In FIG. 3B, it is known that unevenness in color occurs at four corners with respect to the center of a screen, when a level of decrease in signals R, G and B, which occurs when the distance from the center of a circle exceeds a certain length.

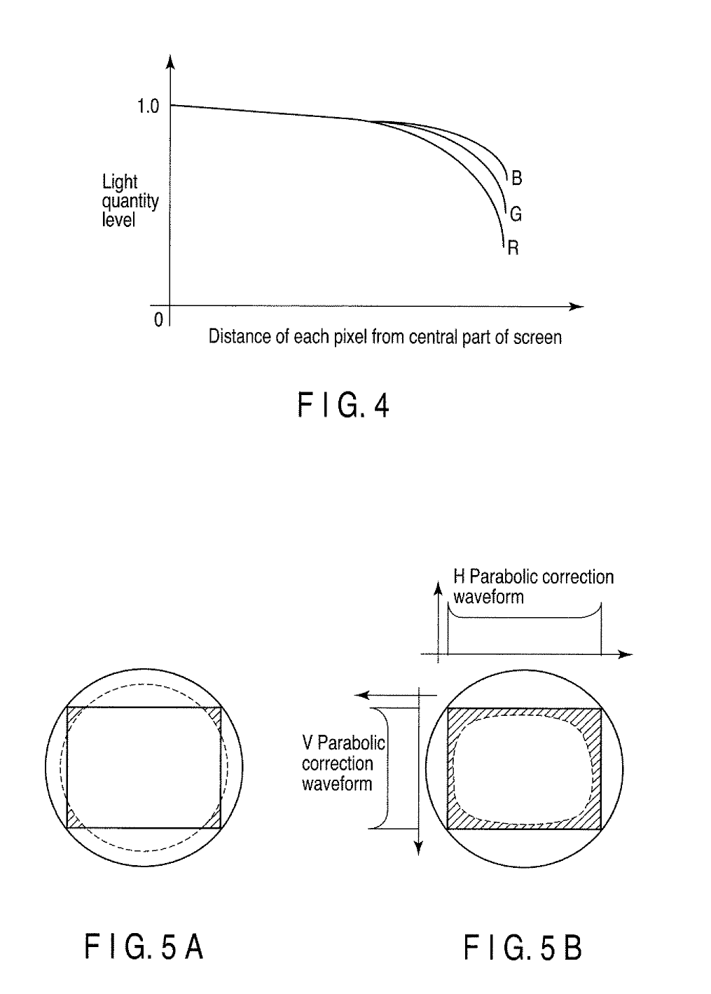

FIG. 4 shows an example of normalization of the influence of ambient light quantity shading to each color shown schematically in FIGS. 3A and 3B, by assuming the light quantity of input image light passing through the center of a lens to be “1”.

As shown in FIG. 4, it is known that color components of input image light gradually decrease as the light passing through the lens center, that is, the distances of pixels from the central part of a screen increase. Further, as seen from FIG. 4, it is also known that even if the distances of pixels from the central part of a screen are the same, the light quantity level differs for each color (color component) separated by a prism.

FIGS. 5A and 5B show an example of parabolic correction, which is widely used for correction of the influence of ambient light quantity shading.

In an imaging apparatus using a lens causing ambient light quantity shading shown in FIG. 5A, correction is usually made in both vertical and horizontal directions, by increasing an image output from a CCD sensor for input image light in the vertical and horizontal directions, in which the distance from a peripheral area, or from the center of a screen is increased farther than a predetermined distance, as shown in FIG. 5B. In contrast, in the parabolic correction shown in FIG. 5B, it is known that necessary memory capacity (required for the correction) is increased.

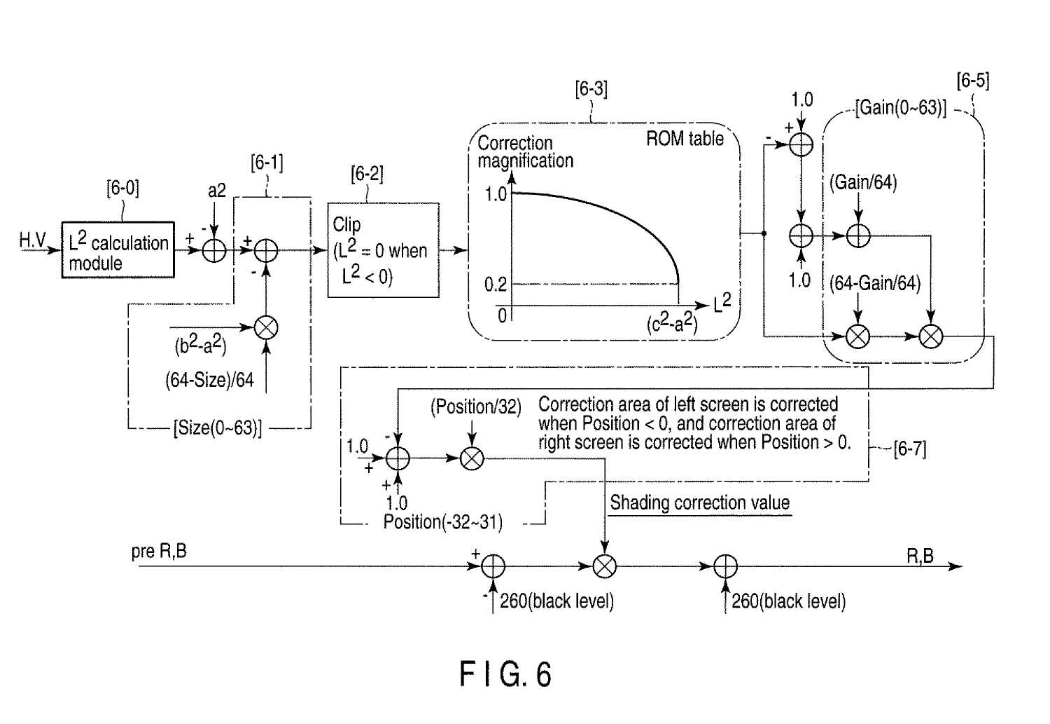

FIG. 6 shows an example of a correction circuit, which realizes correction of ambient light quantity shading of the invention, in which memory capacity can be decreased to be smaller than the parabolic correction explained by using FIG. 5B.

In the ambient light quantity shading correction circuit module 11b shown in FIG. 6, at first, for the pixels to be corrected, a square “L²” of an address distance for each pixel to be corrected is calculated by using a “L²” calculation module ([6-0] in FIG. 6), by using the vertical distance (V) and horizontal distance (H) from the address of the central part of a screen.

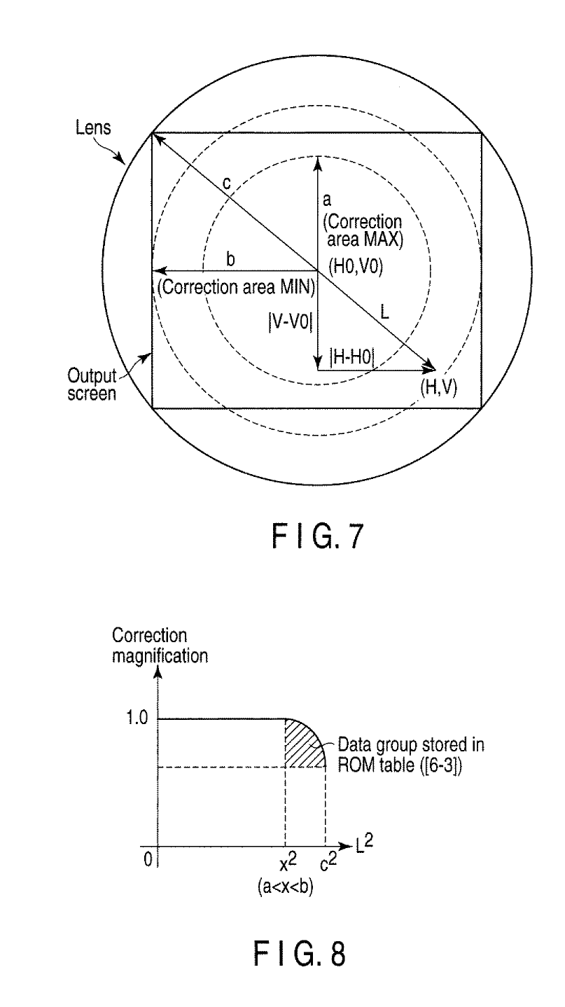

Here, in the output screen shown in FIG. 7, “Size” is defined as a correction area parameter, which comes in a circle with a distance b from the central part of a screen, as a minimum correction area, and comes out of a circle with a distance a, as a maximum correction area. By controlling the radius of the circle, a correction area is adjusted (“Size” calculation module, [6-1] in FIG. 6).

As for the central part of a screen or nearby areas which comes in the circle with a radius a or smaller, the necessity of shading correction is considered to be low, and correction is omitted to decrease the memory capacity (to decrease the scale).

Next, a light quantity unrelated area (an area unnecessary to correct light quantity) subtract a² from L² (having L²−a²) on the X-axis, that is, an attenuation direction waveform is created for the signal R (the output of CCD 7R) and signal B (the output of the CCD 7B), by using trigonometric functions. At this time, an amplification waveform (a waveform in an amplifying direction), which is amplified equivalently to the value of attenuation output from an attenuation waveform (a waveform in an attenuation direction), is also created by calculation ([6-3] in FIG. 6). As for “L²”, “L²<0” is set to “L²=0”, by using a clipping module ([6-2] in FIG. 6).

Then, a “Gain Value” that is a correction value parameter is multiplied by a “Gain” calculation module ([6-5] in FIG. 6), and the product is added to the values (output values) obtained by the amplification waveform (the waveform in an amplifying direction) and the attenuation waveform (the waveform in an attenuation direction). Namely, the amplification degree (rate) of the amplification waveform (the waveform in the amplifying direction) and the attenuation degree (rate) of the attenuation waveform (the waveform in the attenuation direction) can be adjusted by using the “Gain Value”.

The value obtained here is used as a “Position” parameter, and area correction is made for left and right screens ([6-7] in FIG. 6). The “Position” is independent of plus and minus (±). When the “Position” is smaller than 0, a correction area in the left screen is corrected. When the “Position” is larger than 0, a correction area in the right screen is corrected.

More specifically, the distance L² from the address (H₀, V₀) of the center of the screen is obtained from information about input addresses H and V in FIG. 6, according to the theorem of three squares.

Next, “out of a circle with a radius a” is defined as a maximum correction area, and “out of a circle with a radius b” is defined as a minimum correction area, taking the central part of a screen as the center.

Namely, as described above, the necessity of shading correction is considered low for the central part of a screen that is within a circle with a radius a, and shading correction is omitted. At the same time, a light quantity unrelated area (an area unnecessary to correct light quantity) with subtract a² from L² (having L²−a²) on the X-axis, that is, an attenuation direction waveform is created for the signal R (the output of CCD 7R) and signal B (the output of the CCD 7B), by using trigonometric functions.

The (L²−a²) is expressed as follows by using the “Size (0-63)” that is a parameter to control a correction area, according to the ROM table indicated by [6-3] in FIG. 6, considering the relation to the X-axis,

[“L²−a²” after the correction]=(L²−a²)−(b²−a²)×(64−Size)/64.

As for the [“L²−a²” after the correction<0], all are clipped to [0] by the clipping module [6-2], and are input to the ROM table indicated by [6-3] in the same drawing.

The ROM table corresponds to an area (a shaded area in FIG. 8) separated farther than the distance x² from a center image (the center of a screen), in correction characteristics to be explained later by using FIG. 8.

A maximum correction rate (a maximum value of correction magnification in FIG. 8) is assumed to be +80%, for example. A table for correction of maximum attenuation, that is, an attenuation waveform (a waveform in an attenuation direction) and an amplification waveform (a waveform in a amplifying direction) amplified equivalently to the attenuation, is created by calculation.

The correction values (attenuation waveform and amplification waveform) are multiplied and added in the “Gain (0-63)” calculated by gain calculate module [6-5] in FIG. 6. At this time, the system shown in FIG. 6 is designed so that correction of maximum attenuation is output when the “Gain” is zero, and correction of maximum amplification is output when the “Gain” is 63.

The output value is multiplied by the above-described “Position (−32 to 31) or any one in the range of ±32”, as a parameter to adjust a correction area in left and right screens.

The “Position (−32 to 31)” is substantially equivalent to simultaneous correction of “Gain (0 to 63)” and “Size (0 to 63), independent of the left and right screens, and can be regarded as a parameter to correct deviation of the lens optical axis in the horizontal direction at the central part of a screen.

The correction value calculated as described above is used as a correction value for ambient light quantity shading.

In actual processing, a black level value corresponding to “Black”, which it is usually unnecessary to correct, is subtracted for the signals R and B, the difference is multiplied by the correction value for ambient light quantity shading obtained in the above-described process, and the black level value is added to the product, thereby providing final corrected signals R and B.

As described above, an ambient light quantity shading correction system having a parameter correction area and a correction value can be obtained (The above description means a procedure of designing the ambient light quantity shading correction module 11b).

In the above description, the parameters defined as “Size (0-63), “Gain (0-63)”, “Position (−32-31), and maximum correction rate ±80% are just examples, and may be changed to other appropriate values.

As explained herein, by using one of the embodiments of the invention, when the influence of ambient light quantity shading is corrected, exact correction (regional correction) is possible regardless of shading levels. Overcorrection can also be prevented. Namely, in this shading correction method, an ambient light quantity shading image area is considered to be a circle specific to a lens, correction is made based on the distance from a center image (the center of an image) (i.e., a circle), and shading correction is possible without causing differences in color components (unevenness in color). Particularly, in an area where the distance from the center of a screen is farther than a certain distance, when the decrease levels of R, G and B are not even, unevenness in color at the four corners with respect to the center of a screen can be prevented. Overcorrection can also be prevented. Further, the memory capacity to store a correction value can be decreased.

Besides, as it is unnecessary to store a light quantity distribution around a lens, an interchangeable C-mount lens can be used, and the memory capacity to store a correction value can be decreased. Namely, it is unnecessary to adjust a correction value each time a lens is changed, and it is unnecessary to store a correction value for each lens.

Further, in this method, a correction area can be adjusted by controlling the size of a circle from the central part of a screen, and overcorrection can be prevented in an area where correction is unnecessary 1% in case of 2× recording, and it was 6.2% in case of 3× recording.

Therefore, in an imaging apparatus using a triple-CCD imaging apparatus, it is possible to realize an imaging apparatus and an imaging method with ease and low cost, which can easily correct the influence of different decrease levels of signal for each color component as the quantity of ambient light is decreased.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An imaging apparatus comprising:
a CCD sensor which converts input image light to an image signal; and
a shading correction module which corrects the influence of ambient light quantity shading to input image light, for an image signal output from the CCD sensor whose distance from the center of a screen is farther than a predetermined distance, according to a circle with an equal distance from the center of a screen.

2. The imaging apparatus of claim 1, wherein the shading correction module does not make correction for a maximum correction area which is out of a circle with a distance a from the central part of a screen, and corrects the influence of ambient light quantity shading for a minimum correction area with a distance b from the central part of a screen, after calculating a square L² of an address distance of each pixel of a correction object obtained by using a vertical distance and a horizontal distance from an address of the central part of a screen.

3. The imaging apparatus of claim 2, wherein the shading correction module corrects unevenness in color by amplification or attenuation, for two colors among image signals of each color obtained by separating input image light into three primary colors of additive color mixing, with reference to green (G).

4. The imaging apparatus of claim 2, wherein the shading correction module sets a correction amount independently of left and right directions of a screen.

5. The imaging apparatus of claim 2, wherein the shading correction module does not make correction for a maximum correction area which is out of a circle with a distance a from the central part of a screen, as (L²−a²), after calculating a square L² of an address distance of each pixel of a correction object obtained by using a vertical distance and a horizontal distance from an address of the central part of a screen.

6. A method of correcting the influence of ambient light quantity shading in an imaging comprising:
defining a circle with an equal distance from the center of a screen, for an image signal output from a CCD sensor whose distance from the center of a screen is farther than a predetermined distance; and
making no correction for a maximum correction area which is out of a circle with a distance a from the central part of a screen, and setting a correction amount by (L²−a²)−(b²−a²)×(64−Size)/64, for a minimum correction area with a distance b from the central part of a screen, after calculating a square L² of an address distance of each pixel of a correction object obtained by using a vertical distance and a horizontal distance from an address of the central part of a screen.

7. The method of claim 6, wherein a correction amount is settable independently of left and right directions of a screen.
